(19) United States
(12) Patent Application Publication
(10) Pub. No.: US 2008/0092186 A1
(43) Pub. Date: Apr. 17, 2008

(54) Video display with built-in optical drive

(75) Inventors: Rory G. Briski, Bellevue, WA (US); Steven R. Galipeau, Redmond, WA (US)

Correspondence Address: Rory Briski, Suite B, 13200 SE 30th St., Bellevue, WA, 98005, US

(73) Assignee: Avion Engineering Services Inc DBA Avion Partners, Bellevue, WA (US)

(21) Appl. No.: 11/974,149

(22) Filed: Oct. 11, 2007

Related U.S. Application Data
(60) Provisional application No. 60/851,231, filed on Oct. 12, 2006.

(51) Int. Cl. H04N 7/173; H04N 7/16

(52) U.S. Cl. 725/110; 725/145; 725/153

(57) ABSTRACT

A video display capable of receiving, decoding and displaying video content received via a data network while also having the capability to play video content from a built-in optical disk drive.

### BACKGROUND OF THE INVENTION

1. Field of the Invention

This invention relates to an apparatus for displaying video content from a centralized source or from a local source.

2. Description of Related/Prior Art

Existing video monitors in aircraft accept content from a centralized source, and to accommodate a multitude of users complex storage and distribution systems must be installed.

The existing video monitors come in two varieties, fixed or portable. The portable units are typically referred to as video-on-a-stick as they are indeed a video monitor mounted to a simple rod. This rod has a connector attached where the monitor is fed power and video for external devices. Typically, power is fed to the monitors from the aircraft power bus with the video images fed from a centralized video amplifier. The video amplifier typically receives its video content from a bank of video sources.

These lead to a limited number of programming options for most installations.

There remains, therefore, a need for a video display with sufficient input flexibility to support the entertainment needs of passengers, and address the system weight and volume constraints of the aircraft manufacturers, both for the present and the future.

### OBJECTS AND AVANTAGES

Accordingly, several objects and advantages of our invention are:

Our Video display with built-in optical drive allows the user to insert a video disk and enjoy local content or watch movies being broadcast on the data network.

Our Video display with built-in optical drive provides maximum flexibility for receiving power: it can receive power from either the aircraft power grid directly, or via power-over-ethernet from a cabin management system or from another local power source depending upon the installation. Further objects and advantages of our invention will become apparent from a consideration of the drawings and ensuing description.

### BRIEF SUMMARY OF INVENTION

A video display capable of receiving and decoding digital data from a data network while also having the capability to play video content from a built-in optical disk drive.

### DRAWINGS/LIST OF FIGURES

FIG. 1 Video-On-A-Stick with built-In Optical Disc Player and various horizontal mounting options

FIG. 2 Video-on-a-stick block diagram

### DRAWINGS—LIST OF REFERENCE NUMBERS

| Item | Nomenclature |
|---|---|
| 2602 | Rigid mounting arm |
| 2604 | Electrical Connector |
| 2702 | Semi-rigid mounting arm |
| 2706 | Semi-rigid mounting arm |
| 2704 | Semi-rigid mounting arm |
| 2802 | Video Monitor with Built-In Top Load Optical Drive |
| 2803 | Processor and switching circuits |
| 2804 | Video Monitor with Built-In Side Load Optical Drive |
| 2805 | Internal Optical Drive |
| 2806 | Data network interface |
| 2807 | Power Converter |

### DETAILED DESCRIPTION

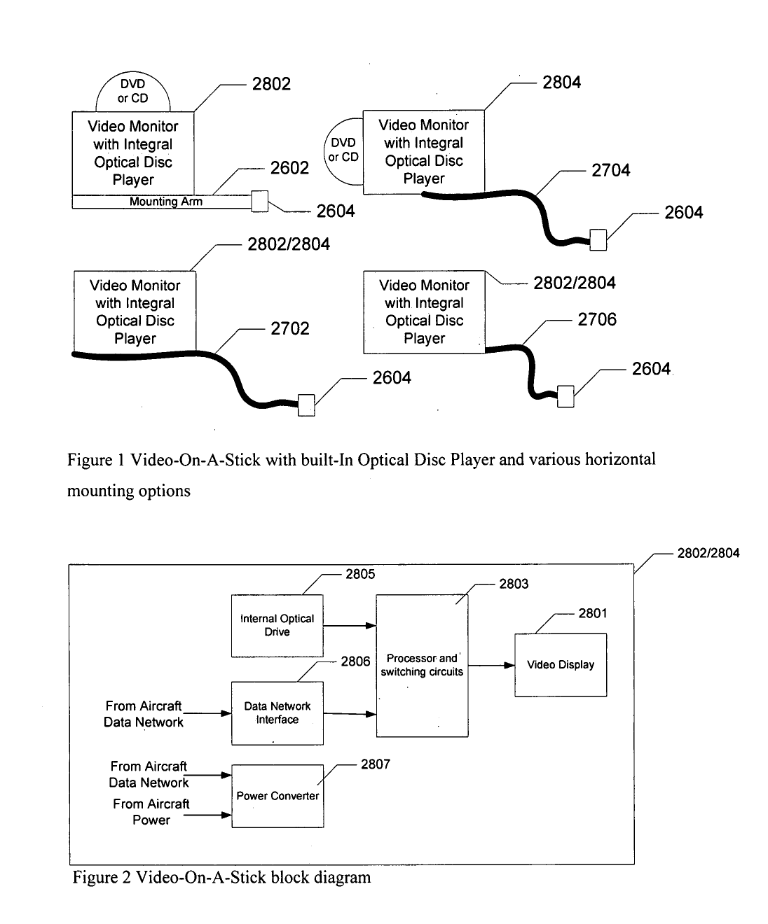

Typically passengers receive video content that is sourced at a central location via a remote video player. FIG. 1 illustrates a video option in which we add a video monitor with built-in Optical Disc player 2802 or 2804 to one of our mounting arms 2602, 2702, 2704 or 2706 and provide the user with the option of viewing video content provided from the head-end or from their own local Optical Disc player built-into the monitor housing. The Optical Disc insertion can be from either the side of the display 2804 or from the top of the display 2802 depending on the combination desired to be installed.

FIG. 2 is the block diagram of the internals of said monitor 2802 or 2804.

The passenger selects which video source they want to use either by using switching circuits 2803 on the monitor 2802/2804 itself, of by issuing commands to the monitor 2802/2804 via the aircraft data network. If a video is being watched that is originating on the data network, then that video will enter the monitor 2802/2804 via the data interface 2806 where it is decoder via the processor 2803 and then sent to the video display 2801. If video is being watched from the local drive 2805 then a disk is inserted and into the drive 2805, the video is output to the processor and switching circuits 2803 where it is transmitted to the video display 2801.

Depending on the needs of the specific installation, power can either be provided directly from the aircraft power grid into power converter 2807, or from the data network as power-over-ethernet which sends power into converter 2807 and data into interface 2806.

What is claimed is:

1) An apparatus for watching video from either a local or remote source comprising:
(a) a video display
(b) an internal optical drive
(c) a data network interface
(d) a power converter
(e) a processor
(f) switching circuits

2) The apparatus in claim 1 wherein the processor includes a multi-cast data receiver

3) The apparatus in claim 1 wherein the power is received via a power-over-ethernet interface

4) An apparatus for watching video from either a local or remote source comprising:
(a) a video display
(b) an internal optical drive
(c) a data network interface
(d) a power converter
(e) a processor
(f) switching circuits
(g) a mounting arm

5) The apparatus in claim 4 wherein the mounting arm is rigid

6) The apparatus in claim 4 wherein the mounting arm is semi-rigid
